(19) United States
(12) Patent Application Publication
(10) Pub. No.: US 2008/0157955 A1
(43) Pub. Date: Jul. 3, 2008

(54) AUXILIARY BRAKE LIGHT ACTIVATING SYSTEM

(76) Inventor: Herbert Wichmann, Jackson, WI (US)

Correspondence Address: ZIOLKOWSKI PATENT SOLUTIONS GROUP, SC (ZPS), 136 S WISCONSIN ST, PORT WASHINGTON, WI, 53074, US

(21) Appl. No.: 11/872,915

(22) Filed: Oct. 16, 2007

Related U.S. Application Data
(60) Provisional application No. 60/852,303, filed on Oct. 18, 2006.

(51) Int. Cl. B60Q 1/30

(52) U.S. Cl. 340/467

(57) ABSTRACT

A brake light illumination system for use with engine braking includes an automatic illuminator switch connected to an engine retarder output line. The automatic illuminator switch is configured to be in a closed position relative to the engine retarder output line when an engine retarder is actuated and in an open position relative to the engine retarder output line when the engine retarder is in an inactive state. The brake light illumination system also includes a diode connected to the automatic illuminator switch. Upon actuation of the engine retarder, the automatic illuminator switch and the diode are electrically connected to a brake light switch to illuminate a plurality of brake lights.

### CROSS-REFERENCE TO RELATED APPLICATIONS

The present application claims the benefit of U.S. provisional application Ser. No. 60/852,303, filed on Oct. 18, 2006, the disclosure of which is incorporated herein by reference.

### BACKGROUND OF THE INVENTION

The present invention relates generally to a brake light activating system and, more particularly, to an auxiliary brake light activation system for use with engine braking.

Engine brakes (i.e., engine retarders) are well known in the prior art as a means for reducing the speed of a vehicle without the use of friction-based braking systems. Engine brakes are most commonly associated with semi-tractor trailers and the use thereby for controlling speed on steep, lengthy declined sections of highway, although they also can be implemented on straight trucks. One of the most common implementations of engine brakes is a Jake brake. In an engine braking process employing a Jake brake, cylinder exhaust valves are opened in an engine when pistons reach top dead centre to vent accumulated compressed air in the cylinder before the air acts as a spring to drive the piston downward. Thus, by way of a Jake brake, the engine acts as an air compressor, with the energy used to compress the air coming from the transmission retarding (i.e., braking) the vehicle.

One problem commonly associated with engine braking, however, is that the engine brake is not tied into the brake light system on the semi-tractor trailer or straight truck. Thus, it is possible for the semi-tractor trailer or truck to be decelerating via engine braking without the brake lights on the trailer illuminating. Such failure of the brake lights to illuminate when the semi-tractor trailer/truck is reducing its speed can create a driving hazard for vehicles following there behind.

Therefore, it would be desirable to design a system that acts to illuminate brake lights on a semi-tractor trailer or straight truck upon sensing activation of an engine brake. It would also be desirable for such a system to be wired into the electrical line system of the brakes and allow for illumination also upon application of standard brakes.

### BRIEF DESCRIPTION OF THE INVENTION

The present invention is directed to an auxiliary brake light activation system for use with engine braking.

In accordance with one aspect of the invention, a brake light illumination system includes an automatic illuminator switch connected to an engine retarder output line. The automatic illuminator switch is configured to be in a closed position relative to the engine retarder output line when an engine retarder is actuated and in an open position relative to the engine retarder output line when the engine retarder is in an inactive state. The brake light illumination system also includes a diode connected to the automatic illuminator switch. Upon actuation of the engine retarder, the automatic illuminator switch and the diode are electrically connected to a brake light switch to illuminate a plurality of brake lights.

In accordance with another aspect of the invention, an engine retarder lighting system includes a plurality of brake lights mounted on a rear of a vehicle and a brake light switch connected to the plurality of brake lights, the brake light switch configured to illuminate the plurality of brake lights upon the receipt of power from a power source. The engine retarder lighting system also includes an on-off switch configured to provide power to an engine retarder and an engine retarder switch connected to an accelerator in the vehicle configured to activate and deactivate the engine retarder when the engine retarder is provided with power. The engine retarder switch is in an open position when the accelerator is depressed by an operator and in a closed position when the accelerator is released. The engine retarder lighting system further includes an illuminator relay connected to the engine retarder switch and the brake light switch that is in electrical communication with the engine retarder when the engine retarder is activated by the engine retarder switch. The illuminator relay is not in electrical communication with the engine retarder when the engine retarder is deactivated by the engine retarder switch. The engine retarder lighting system also includes a diode connected between the brake light switch and the illuminator relay to prevent feedback from the brake light switch to the illuminator relay. The brake light switch in the engine retarder lighting system is supplied with power upon activation of the engine retarder and electrical communication between the illuminator relay and the engine retarder switch, thus causing the plurality of brake lights to be illuminated.

In accordance with yet another aspect of the invention, an auxiliary brake light system kit for retrofitting an electrical brake line includes a stop alert relay configured to be selectively electrically connected to a throttle switch configured to control actuation of an engine brake and electrically connected to a brake light switch. The auxiliary brake light system kit also includes a diode electrically connected between the stop alert relay and the brake light switch to prevent feedback therebetween. The stop alert relay is electrically connected to the throttle switch when the engine brake is in an actuated state, and when the stop alert relay is electrically connected to the throttle switch, a plurality of brake lights illuminate in response to the engine brake actuation.

Various other features and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is a pictorial view of a semi-trailer.

FIG. 2 is a schematic diagram of an engine retarder lighting system according to the present invention.

### DETAILED DESCRIPTION OF THE PREFERRED EMBODIMENT

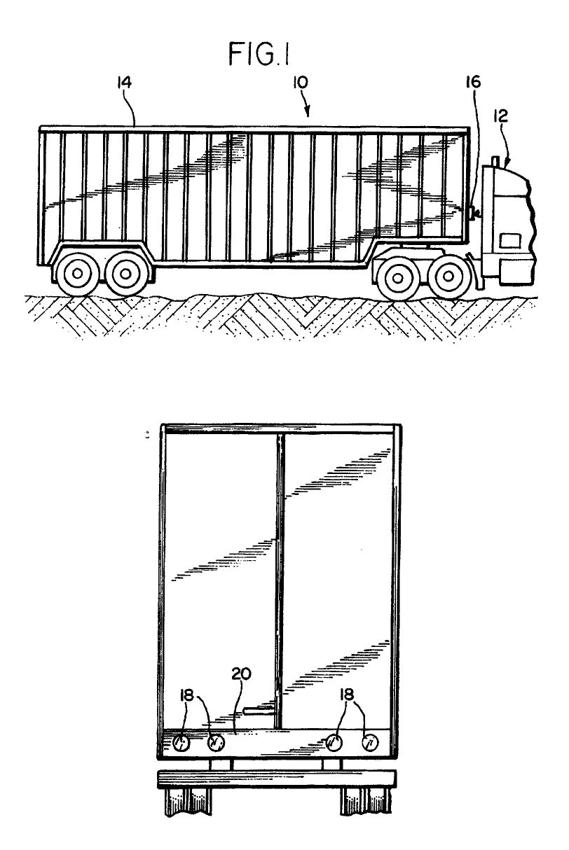

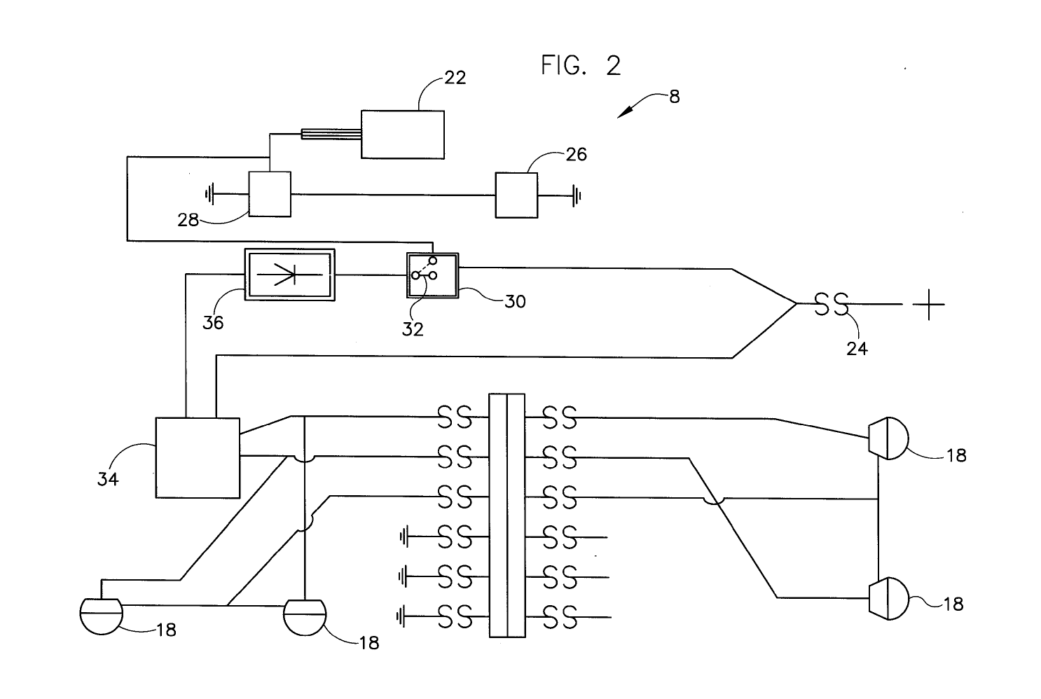

The present invention provides a brake light illumination system 8 (illustrated in FIG. 2) useable with a semi tractor-trailer 10 as shown in FIG. 1. An electrical connection is provided between the tractor 12 and the trailer 14 of the semi tractor-trailer 10 through an electrical connector 16. The brake light illumination system operates to illuminate brake lights 18 mounted on a sill 20 at the rear of trailer 14 and also lights (not shown) on the rear of tractor 12.

The tractor-trailer 10 includes a primary service brake system (not shown) for reducing the speed of the vehicle. Additionally, the tractor-trailer is fitted with an engine brake 22, as shown in FIG. 2. Referring now to FIG. 2, a circuit schematic of an electrical brake line and the brake light illumination system 8 (i.e., engine retarder lighting system, auxiliary brake light system) is shown connected to engine brake 22. Brake light illumination system 8 is provided with power from a vehicular power source 24, such as a battery. As will be described below, upon actuation of engine brake 22, brake light illumination system 8 causes power to be supplied to brake lights 18, which in turn cause brake lights 18 to illuminate.

Included in brake light illumination system 8 is an on-off switch 26 connected to engine brake 22 that controls power input to, and deployment of, engine brake 22. The on-off switch may be a manual switch that is operated by a driver, or alternatively, may be an automatic switch that is closed upon a sensed need for deployment of the engine brake 22. Also connected to engine brake 22 is a throttle switch 28 (i.e., engine retarder switch) configured to control actuation/activation and deactivation of the engine brake when the engine brake is provide with power. Throttle switch 28 is electrically grounded and is connected to an accelerator pedal (not shown), functioning to actuate and deactivate the engine brake 22 upon depression and release of the accelerator. More specifically, throttle switch 28 operates in an open position and deactivates engine brake 22 when the accelerator is depressed by a driver. The throttle switch 28 flips to a closed position when the accelerator is released by the driver, thus actuating the engine brake 22.

When throttle switch 28 is in a closed position, actuation of engine brake 22 is sensed by an illuminator relay 30 (i.e., automatic illuminator switch, stop alert relay) that is selectively electrically connected to the throttle switch 28. The illuminator relay 30 includes an arm 32 that is generally in an open state/position in relation to the throttle switch 28 such that there is no electrical communication therebetween; however, upon actuation of engine brake 22 by way of throttle switch 28, arm 32 pivots such that an electrical connection between throttle switch 28 and the relay 30 is created (i.e., a closed state/position between arm 32 and throttle switch 28 is created). In the embodiment of FIG. 2, illuminator relay 30 is a single pole double throw relay. However, it is also envisioned that illuminator relay be in the form of a double pole double throw relay, or any other suitable relay device.

Also connected to illuminator relay 30 is a brake light switch 34. Brake light switch 34 is further connected to power source 24 and to brake lights 18. In operation, brake light switch 34 acts to illuminate brake lights 18 upon being supplied with power (from battery 24) and upon a signal from illuminator relay 30 and throttle switch 28 that engine brake 22 has been actuated. That is, upon deployment of engine brake 22 and upon the lack of depression the accelerator pedal and accompanying closing of throttle switch 28, a closed circuit is created between engine brake 22 and brake light switch 34, causing brake lights 18 to illuminate. Thus, actuation of the engine brake 22 and the resulting reduction in speed of the semi tractor-trailer 10 (shown in FIG. 1) is relayed to trailing drivers by illumination of the brake lights 18. Additionally, the brake light switch 34 is further connected to a brake pedal (not shown) for being supplied with power upon depression of the brake pedal, thus again causing brake lights 18 to be illuminated.

Also included in brake light illumination system 8 is a diode 36 that is positioned in the circuit between illumination relay 30 and brake light switch 34. Diode 36 serves to prevent feedback from the brake light switch 34 to the illuminator relay 30. That is, diode 36 is configured to allow electric current flow from illuminator relay 30 to brake light switch 34 and prevent electric current flow from brake light switch 34 to illuminator relay 30. In one embodiment, diode is a 35 amp diode (e.g., Delco Remy 35 amp diode) capable of handling amp loads typically encountered in an electrical brake line system.

The above mentioned brake light illumination system 8 can be added to an existing electrical brake line to retrofit the existing brake light system. In retrofitting an existing electrical brake line, stop alert relay 30 is wired into the existing electrical line system such that it is selectively electrically connected with throttle switch 28. Connection of stop alert relay 30 to throttle switch 28 allows for determination of when engine retarder 22 is actuated. Stop alert relay 30, along with diode 36, are then wired to brake light switch 34 to complete the retrofitting, thus allowing brake lights 18 to illuminate upon actuation of engine retarder 22.

While described above for use with a semi tractor-trailer, it is also understood that brake light illumination system 8 can be included in a straight truck or any other vehicle that utilizes an engine brake for reducing speed. In such an embodiment, brake light illumination system 8 would be tied into the brake lights on the rear of the straight truck/vehicle.

Therefore, according to one embodiment of the present invention, a brake light illumination system includes an automatic illuminator switch connected to an engine retarder output line. The automatic illuminator switch is configured to be in a closed position relative to the engine retarder output line when an engine retarder is actuated and in an open position relative to the engine retarder output line when the engine retarder is in an inactive state. The brake light illumination system also includes a diode connected to the automatic illuminator switch. Upon actuation of the engine retarder, the automatic illuminator switch and the diode are electrically connected to a brake light switch to illuminate a plurality of brake lights.

According to another embodiment of the present invention, an engine retarder lighting system includes a plurality of brake lights mounted on a rear of a vehicle and a brake light switch connected to the plurality of brake lights, the brake light switch configured to illuminate the plurality of brake lights upon the receipt of power from a power source. The engine retarder lighting system also includes an on-off switch configured to provide power to an engine retarder and an engine retarder switch connected to an accelerator in the vehicle configured to activate and deactivate the engine retarder when the engine retarder is provided with power. The engine retarder switch is in an open position when the accelerator is depressed by an operator and in a closed position when the accelerator is released. The engine retarder lighting system further includes an illuminator relay connected to the engine retarder switch and the brake light switch that is in electrical communication with the engine retarder when the engine retarder is activated by the engine retarder switch. The illuminator relay is not in electrical communication with the engine retarder when the engine retarder is deactivated by the engine retarder switch. The engine retarder lighting system also includes a diode connected between the brake light switch and the illuminator relay to prevent feedback from the brake light switch to the illuminator relay. The brake light switch in the engine retarder lighting system is supplied with power upon activation of the engine retarder and electrical communication between the illuminator relay and the engine retarder switch, thus causing the plurality of brake lights to be illuminated.

According to yet another embodiment of the present invention, an auxiliary brake light system kit for retrofitting an electrical brake line includes a stop alert relay configured to be selectively electrically connected to a throttle switch configured to control actuation of an engine brake and electrically connected to a brake light switch. The auxiliary brake light system kit also includes a diode electrically connected between the stop alert relay and the brake light switch to prevent feedback therebetween. The stop alert relay is electrically connected to the throttle switch when the engine brake is in an actuated state, and when the stop alert relay is electrically connected to the throttle switch, a plurality of brake lights illuminate in response to the engine brake actuation.

The present invention has been described in terms of the preferred embodiment, and it is recognized that equivalents, alternatives, and modifications, aside from those expressly stated, are possible and within the scope of the appending claims.

What is claimed is:

1. A brake light illumination system comprising:
an automatic illuminator switch connected to an engine retarder output line, wherein the automatic illuminator switch is configured to be in a closed position relative to the engine retarder output line when an engine retarder is actuated and wherein the automatic illuminator switch is configured to be in an open position relative to the engine retarder output line when the engine retarder is in an inactive state;
a diode connected to the automatic illuminator switch; and
wherein the automatic illuminator switch and the diode are electrically connected to a brake light switch to illuminate a plurality of brake lights upon actuation of the engine retarder.

2. The brake light illumination system of claim 2 wherein the engine retarder output line further comprises a throttle switch to switch the engine retarder between the actuated and inactive states.

3. The brake light illumination system of claim 2 wherein the throttle switch is electrically grounded.

4. The brake light illumination system of claim 1 wherein the automatic illuminator switch is a single pole double throw relay.

5. The brake light illumination system of claim 1 wherein the automatic illuminator switch is a double pole double throw relay.

6. The brake light illumination system of claim 1 wherein the plurality of brake lights comprises tractor brake lights and trailer brake lights on a semi tractor-trailer.

7. The brake light illumination system of claim 1 wherein the diode comprises a 35 amp diode configured to prevent feedback from the brake light switch to the automatic illuminator switch.

8. An engine retarder lighting system comprising:
a plurality of brake lights mounted on a rear of a vehicle;
a brake light switch connected to the plurality of brake lights, the brake light switch configured to illuminate the plurality of brake lights upon the receipt of power from a power source;
an on-off switch configured to provide power to an engine retarder;
an engine retarder switch connected to an accelerator in the vehicle and configured to activate and deactivate the engine retarder when the engine retarder is provided with power, the engine retarder switch being in an open position when the accelerator is depressed by an operator and being in a closed position when the accelerator is released;
an illuminator relay connected to the engine retarder switch and the brake light switch, the illuminator relay in electrical communication with the engine retarder when the engine retarder is activated by the engine retarder switch and the illuminator relay not in electrical communication with the engine retarder when the engine retarder is deactivated by the engine retarder switch;
a diode connected between the brake light switch and the illuminator relay to prevent feedback from the brake light switch to the illuminator relay; and
wherein the brake light switch is supplied with power to illuminate the plurality of brake lights upon activation of the engine retarder and electrical communication between the illuminator relay and the engine retarder switch.

9. The engine retarder lighting system of claim 8 wherein the illuminator relay is a single pole double throw relay.

10. The engine retarder lighting system of claim 8 wherein the illuminator relay is a double pole double throw relay.

11. The engine retarder lighting system of claim 8 wherein the power source further comprises a battery configured to provide power to the brake light switch.

12. The engine retarder lighting system of claim 8 wherein the brake light switch is further connected to a brake pedal, the brake light switch supplied with power upon the depression of the brake pedal.

13. The engine retarder lighting system of claim 8 wherein the vehicle comprises a semi tractor-trailer and wherein the plurality of brake lights comprises tractor brakes lights and trailer brake lights.

14. The engine retarder lighting system of claim 8 wherein the vehicle comprises a straight truck and wherein the plurality of brake lights comprises rear brake lights.

15. The engine retarder lighting system of claim 8 wherein the illuminator relay is generally in an open state such that there is no electrical communication between the illuminator relay and the engine retarder.

16. The engine retarder lighting system of claim 8 wherein the diode comprises a 35 amp diode.

17. An auxiliary brake light system kit for retrofitting an electrical brake line, the auxiliary brake light system kit comprising:
a stop alert relay configured to be selectively electrically connected to a throttle switch and electrically connected to a brake light switch, the throttle switch configured to control actuation of an engine brake;
a diode electrically connected between the stop alert relay and the brake light switch to prevent feedback therebetween;
wherein the stop alert relay is electrically connected to the throttle switch when the engine brake is in an actuated state; and
wherein, when the stop alert relay is electrically connected to the throttle switch, a plurality of brake lights illuminate in response to the engine brake actuation.

18. The auxiliary brake light system kit for retrofitting an electrical brake line of claim 17 wherein the stop alert relay comprises a single pole double throw relay.

19. The auxiliary brake light system kit for retrofitting an electrical brake line of claim 17 wherein the stop alert relay comprises a double pole double throw relay.

20. The auxiliary brake light system kit for retrofitting an electrical brake line of claim 17 wherein the diode comprises a 35 amp diode.
